(19) United States
(12) Patent Application Publication
(10) Pub. No.: US 2023/0149266 A1
(43) Pub. Date: May 18, 2023

(54) ENTERNAL FEEDING TUBE

(71) Applicant: WERD, LLC, Lexington, KY (US)

(72) Inventors: David S. KIRN, Lexington, KY (US); Richard D. HISEL, Nicholasville, KY (US); William WHITMAN, Lexington, KY (US)

(21) Appl. No.: 17/919,790

(22) PCT Filed: May 4, 2020
(86) PCT No.: PCT/US2020/031280

§ 371 Date: Oct. 19, 2022

(51) Int. Cl. A61J 15/00

(52) U.S. Cl. CPC A61J 15/0003; A61J 15/0026

(57) ABSTRACT

An enteral feeding tube includes a tube body particularly adapted or configured to resist kinking and clogging. That tube body is characterized by a particular equation.

### TECHNICAL FIELD

This document generally relates to enteral feeding tubes and, more particularly to, new and improved enteral feeding tubes configured to resist (a) kinking during placement and use and (b) clogging with particulate matter, such as crushed pills, and viscous fluids, such as enteral feeding formulas, that move slowly through the enteral feeding tube.

### BACKGROUND

As is known in the art, enteral feeding tubes allow the delivery of nutrition and medicine directly to the stomach, duodenum or small intestine of a patient.

Most commonly, enteral feeding tubes are placed into the gastrointestinal tract via the nose or mouth of the patient. As such, the enteral feeding tube is required to make a sharp turn or bend as the enteral feeding tube passes into the nasopharynx. Accordingly, one important design parameter of an enteral feeding tube is resistance to kinking during placement and use so that nutrition and medicine may be administered through the enteral feeding tube without impediment.

Generally, nutrition is provided to a patient through the enteral feeding tube by delivering an enteral feeding formula directly into the stomach, duodenum or the small intestine. Many enteral feeding formulae have a relatively high viscosity that has a tendency to creep slowly from the proximal end toward the distal end of the enteral feeding tube where the enteral feeding formula is discharged. Under certain circumstances, the enteral feeding formula may partially or fully clog the tube and require dislodging to reestablish proper flow through the tube into the stomach, duodenum or small intestine.

Often medicine is also delivered to the patient through the enteral feeding tube. The medicine may comprise crushed pills or other particulate matter that can have a further tendency to clog the lumen of the enteral feeding tube. Accordingly, it should be appreciated that resistance to clogging is another important design parameter of an enteral feeding tube.

This document relates to a new and improved enteral feeding tube that is particularly resistant to both (a) kinking during placement and use as well as (b) clogging with particulate matter, such as crushed pills, and viscous fluids, such as enteral feeding formulae. As such, the new and improved enteral feeding tube provides significant benefits and advantages and represents a significance advance in the enteral feeding tube art.

### SUMMARY

In accordance with the purposes and benefits described herein, a new and improved enteral feeding tube is provided. That enteral feeding tube comprises a tube body characterized by an equation OD^{x}/t=C where

OD=outer diameter of the tube body,

t=wall thickness of the tube body,

C is a constant having a value between 6.0 and 17.0 and X=1.5, 1.25 or 1.75.

In one or more of the many possible embodiments of the enteral feeding tube, the tube body includes a proximal end, a distal end and an intermediate portion. The inner diameter and the outer diameter of the intermediate portion increases toward the distal end so as to resist clogging.

In one or more of the many possible embodiments of the enteral feeding tube, the intermediate portion has a taper ratio (diameter increase/length increase) between about 0.004 cm/cm and 0.00015 cm/cm.

In one or more of the many possible embodiments of the enteral feeding tube, the intermediate portion has a taper ratio between about 0.004 and 0.0006 cm/cm.

In one or more of the many possible embodiments of the enteral feeding tube, the intermediate portion has a taper ratio between about 0.0015 and 0.00015 cm/cm.

In one or more of the many possible embodiments of the enteral feeding tube, the intermediate portion has a taper ratio between about 0.00129 and 0.000516 cm/cm.

In one or more of the many possible embodiments of the enteral feeding tube, the tube body further includes a proximal end portion extending from the proximal end to the intermediate portion. The tube body may also include a distal end portion extending from the distal end to the intermediate portion. The proximal end portion may have a constant internal diameter A and the distal end portion may have a constant internal diameter B where A<B.

More specifically, A may be between about 1.25 and 2.27 mm and B may be between about 1.72 and 2.75 mm. In other possible embodiments, (a) A is 2.27 mm and B is 2.75 mm, (b) A is 1.89 mm and B is 2.41 mm or (c) A is 1.25 mm and B is 1.72 mm.

In one or more of the many possible embodiments of the enteral feeding tube, the tube body has a total length L, the proximal end portion and the distal end portion both have a length of about 0.0071 L to 0.0526 L and the intermediate portion has a length of about 0.895 L to 0.986 L.

In one or more of the many possible embodiments of the enteral feeding tube, the tube body has a total length L, the proximal end portion and the distal end portion both have a length of about 0.0091 L to 0.0182 L and the intermediate portion has a length of about 0.964 L to 0.982 L.

In one or more of the many possible embodiments of the enteral feeding tube, the tube body has a total length L, the proximal end portion and the distal end portion both have a length of about 0.0071 L to 0.0142 L and the intermediate portion has a length of about 0.971 L to 0.986 L.

In one or more of the many possible embodiments of the enteral feeding tube, the tube body has a total length L, the proximal end portion and the distal end portion both have a length of about 0.0263 L to 0.0526 L and the intermediate portion has a length of about 0.895 L to 0.947 L.

In one or more of the many possible embodiments of the enteral feeding tube, the tube body has a total length L, the proximal end portion and the distal end portion both have a length of about 0.0182 L to 0.0364 L and the intermediate portion has a length of about 0.927 L to 0.964 L.

In one or more of the many possible embodiments of the enteral feeding tube, C=11.5 to 18.0. In other embodiments, C=8.0 to 12.5. In still other embodiments, C=6.0 to 8.0.

In one or more of the many possible embodiments of the enteral feeding tube, X=1.5. In other possible embodiments, X=1.25. In still other possible embodiments, X=1.75.

In one or more of the many possible embodiments of the enteral feeding tube, the tube body has a second moment of inertia of between about 0.000011 and 0.000032. In other possible embodiments, the tube body has a second moment of inertia of between about 0.000004 and 0.00002. In still other possible embodiments, the tube body has a second moment of inertia of between about 0.0000004 and 0.000005.

In one or more of the many possible embodiments of the enteral feeding tube, the tube body is made from a material having a Shore hardness of between about 70-90 A. In still other embodiments, the tube body may be made from a material having a Shore hardness of about 85 A.

In one or more of the many possible embodiments of the enteral feeding tube, the tube body is made from a polyurethane material.

In one or more of the many possible embodiments of the enteral feeding tube, the proximal end of the tube body is connected to a Y port. In other embodiments, the proximal end may be connected to an ENFIT adapter. In some embodiments, the distal end has a rounded edge. That rounded edge may have a radius of curvature of about 0.12-0.355 mm. In one or more of the many possible embodiments, the distal end is connected to a rounded tip with an exit vent.

In one or more of the many possible embodiments of the enteral feeding tube, the tube body includes a lubricious coating. That coating may be on an exterior wall surface of the tube body, on an interior wall surface of the tube body that defines a lumen in the tube body or on both the exterior and interior wall surfaces of the tube body.

In one or more of the many possible embodiments of the enteral feeding tube, the enteral feeding tube includes an enteral feeding formula in the tube body wherein the enteral feeding formula moves unidirectionally from the proximal end toward the distal end and is discharged from the distal end.

In one or more of the many possible embodiments of the enteral feeding tube, the tube body is stiffer at the proximal end than the distal end.

In one or more of the many possible embodiments of the enteral feeding tube, the enteral feeding tube includes size and length markings on the tube body.

In one or more of the many possible embodiments of the enteral feeding tube, the tube body includes a radiopaque marker.

In one or more of the many possible embodiments of the enteral feeding tube, the tube body has a proximal end portion outer diameter of between about 1.58 mm and 3.40 mm and a proximal end portion inner diameter of between about 1.25 mm and 2.27 mm. In other possible embodiments, the tube body has a distal end portion outer diameter of between about 2.30 mm and 4.17 mm and a distal end portion inner diameter of between about 1.72 mm and 2.75 mm.

In accordance with an additional aspect, an enteral feeding tube comprises a tube body having a proximal end portion, a distal end portion and an intermediate tapering portion between the proximal end portion and the distal end portion wherein the tube body has a total length of L, the proximal end portion and the distal end portion both have a length of about 0.0071 L to 0.0526 L and the intermediate tapered portion has a length of about 0.895 L to 0.986 L.

In one or more of the many possible embodiments of the enteral feeding tube, the proximal end portion and the distal end portion have a length of about 0.0091 L to 0.0182 L and the intermediate tapered portion has a length of about 0.964 L to 0.982 L. In other possible embodiments, the proximal end portion and the distal end portion have a length of about 0.0071 L to 0.0142 L and the intermediate tapered portion has a length of about 0.971 L to 0.98 L. In still other possible embodiments, the proximal end portion and the distal end portion have a length of about 0.0263 L to 0.0526 L and the intermediate tapered portion has a length of about 0.895 L to 0.947 L. In yet other embodiments, the proximal end portion and the distal end portion have a length of about 0.0182 L to 0.0364 L and the intermediate tapered portion has a length of about 0.927 L to 0.964 L.

In one or more of the many possible embodiments of the enteral feeding tube, the intermediate portion has a taper ratio between about 0.004 cm/cm and 0.00015 cm/cm. In other embodiments of the enteral feeding tube, the intermediate portion has a taper ratio between about 0.004 and 0.0006 cm/cm. In still other embodiments of the enteral feeding tube, the intermediate portion has a taper ratio between about 0.0015 and 0.00015 cm/cm. In yet other embodiments of the enteral feeding tube, the intermediate portion has a taper ratio between about 0.00129 and 0.000516 cm/cm.

In one or more of the many possible embodiments of the enteral feeding tube, the tube body further includes a proximal end portion extending from the proximal end to the intermediate portion. The tube body may also include a distal end portion extending from the distal end to the intermediate portion. The proximal end portion may have a constant internal diameter A and the distal end portion may have a constant internal diameter B where A<B.

More specifically, A may be between about 1.25 and 2.27 mm and B may be between about 1.72 and 2.75 mm. In other possible embodiments, (a) A is 2.27 mm and B is 2.75 mm, (b) A is 1.89 mm and B is 2.41 mm or (c) A is 1.25 mm and B is 1.72 mm.

In one or more of the many possible embodiments of the enteral feeding tube, the tube body has a second moment of inertia of between about 0.000011 and 0.000032. In other possible embodiments, the tube body has a second moment of inertia of between about 0.000004 and 0.00002. In still other possible embodiments, the tube body has a second moment of inertia of between about 0.0000004 and 0.000005.

In one or more of the many possible embodiments of the enteral feeding tube, the tube body is made from a material having a Shore hardness of between about 70-90 A. In still other embodiments, the tube body may be made from a material having a Shore hardness of about 85 A.

In one or more of the many possible embodiments of the enteral feeding tube, the tube body is made from a polyurethane material.

In one or more of the many possible embodiments of the enteral feeding tube, the proximal end of the tube body is connected to a Y port. In other embodiments, the proximal end may be connected to an ENFIT adapter. In some embodiments, the distal end has a rounded edge. That rounded edge may have a radius of curvature of 0.12 mm. In one or more of the many possible embodiments, the distal end is connected to a rounded tip with an exit vent.

In one or more of the many possible embodiments of the enteral feeding tube, the tube body includes a lubricious coating. That coating may be on an exterior wall surface of the tube body, on an interior wall surface of the tube body that defines a lumen in the tube body or on both the exterior and interior wall surfaces of the tube body.

In one or more of the many possible embodiments of the enteral feeding tube, the enteral feeding tube includes an enteral feeding formula in the tube body wherein the enteral feeding formula moves unidirectionally from the proximal end toward the distal end and is discharged from the distal end.

In one or more of the many possible embodiments of the enteral feeding tube, the tube body is stiffer at said proximal end than said distal end.

In one or more of the many possible embodiments of the enteral feeding tube, the enteral feeding tube includes size and length markings on the tube body.

In one or more of the many possible embodiments of the enteral feeding tube, the tube body includes a radiopaque marker.

In the following description, there are shown and described several preferred embodiments of the enteral feeding tube. As it should be realized, the enteral feeding tube is capable of other, different embodiments and its several details are capable of modification in various, obvious aspects all without departing from the enteral feeding tube as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the apparatus and method and together with the description serve to explain certain principles thereof.

FIG. 1 is a longitudinal cross-sectional view of one possible embodiment of the new and improved enteral feeding tube.

FIG. 2 is a transverse cross-sectional view of the enteral feeding tube illustrated in FIG. 1.

FIG. 3a is a detailed perspective view of the proximal end of the enteral feeding tube connected to Y port.

FIG. 3b is a detailed perspective view of the proximal end of the enteral feeding tube connected to an ENFIT Y-port adapter.

FIG. 4 is a detailed perspective view of the distal end of the enteral feeding tube connected to a feeding tip.

FIG. 5 is a perspective view illustrating the rounded end or edge at the distal end of the tube body.

### DETAILED DESCRIPTION

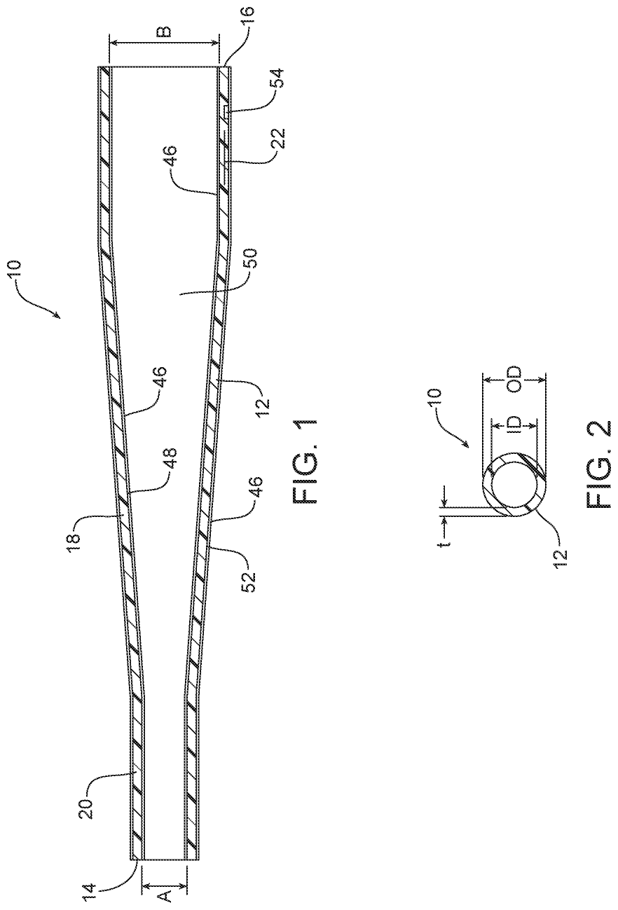

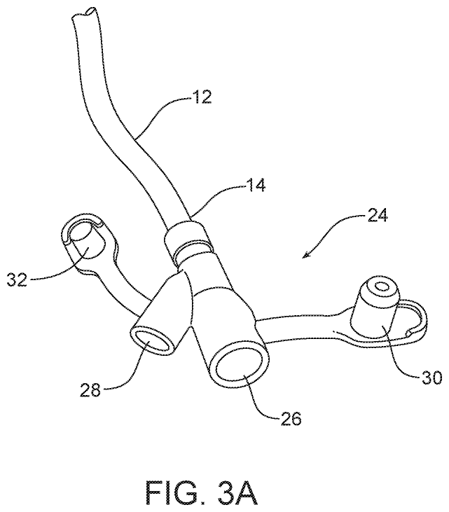

Reference is now made to FIGS. 1 and 2 which illustrate one possible embodiment of the new and improved enteral feeding tube 10. The enteral feeding tube has a tube body 12 including a proximal end 14, a distal end 16 and an intermediate portion 18.

More specifically, the intermediate portion 18 is of tapered construction, having an inner diameter ID and an outer diameter OD that increase toward the distal end. The intermediate portion 18 may have a taper ratio (i.e. diameter increase/length increase) between 0.004 and 0.00015.

For example, a 5 French (Fr) to 6 Fr diameter enteral feeding tube 10 may have a taper ratio of between 0.004 and 0.0006. An 8 Fr to 10 Fr diameter enteral feeding tube 10 may have a taper ratio of between 0.0015 and 0.00015. A 10 Fr to 12 Fr diameter enteral feeding tube 10 may have a taper ratio of between 0.00129 and 0.000516.

The tube body 12 further includes (a) a proximal end portion 20 extending from the proximal end 14 to the intermediate portion 18 and (b) a distal end portion 22 extending from the distal end 16 to the intermediate portion 18. In one or more of the many possible embodiments of the enteral feeding tube 10, the proximal end portion 20 may have a constant internal diameter A. The distal end portion 22 may have a constant internal diameter B where A<B. The internal diameter A of the proximal end portion 20 may be between about 1.25 and 2.27 mm while the internal diameter B of the distal end portion 22 may be between about 1.72 and 2.75 mm. Advantageously, the tube body 12 is stiffer at the proximal end portion 20 than the distal end portion 22. As a result, the proximal end portion 20 has the necessary stiffness to resist kinking around a minimum bend radius such as is encountered with placement at the nasopharynx while the distal end of the tube 10 is more flexible for following the curves of the gastrointestinal tract during placement.

For example, a 5-6 Fr diameter enteral feeding tube 10 may have a length of 380-550 mm, an internal diameter A of 1.25 mm at the proximal end portion 20, an internal diameter B of 1.72 mm at the distal end portion 22, an outer diameter of 1.58 mm at the proximal end portion and an outer diameter of 2.3 mm at the distal end portion. Thus, a 5-6 FR diameter enteral feeding tube 10 may have a wall thickness of 0.17 mm at the proximal end portion 20 and a wall thickness of 0.29 mm at the distal end portion 22.

For example, a 8-10 Fr diameter enteral feeding tube 10 may have a length of 1100-1400 mm, an internal diameter A of 1.89 mm at the proximal end portion 20, an internal diameter B of 2.41 mm at the distal end portion 22, an outer diameter of 2.58 mm at the proximal end portion and an outer diameter of 3.5 mm at the distal end portion. Thus, an 8-10 FR diameter enteral feeding tube 10 may have a wall thickness of 0.35 mm at the proximal end portion 20 and a wall thickness of 0.55 mm at the distal end portion 22.

For example, a 10-12 Fr diameter enteral feeding tube 10 may have a length of 1100-1400 mm, an internal diameter A of 2.27 mm at the proximal end portion 20, an internal diameter B of 2.75 mm at the distal end portion 22, an outer diameter of 3.25 mm at the proximal end portion and an outer diameter of 4.17 mm at the distal end portion. Thus, a 10-12 FR diameter enteral feeding tube 10 may have a wall thickness of 0.49 mm at the proximal end portion 20 and a wall thickness of 0.71 mm the distal end portion 22.

Where the tube body 12 has a total length L, the proximal end portion 20 and the distal end portion 22 may both have a length of about 0.0071 L to 0.0526 L and the intermediate portion 18 may have a length of about 0.895 L to 0.986 L.

Where the tube body 12 has a total length L, the proximal end portion 20 and the distal end portion 22 may both have a length of about 0.0091 L to 0.0182 L and the intermediate portion 18 may have a length of about 0.964 L to 0.982 L.

Where the tube body 12 has a total length L, the proximal end portion 20 and the distal end portion 22 may both have a length of about 0.0071 L to 0.0142 L and the intermediate portion 18 may have a length of about 0.971 L to 0.986 L.

Where the tube body 12 has a total length L, the proximal end portion 20 and the distal end portion 22 may both have a length of about 0.0263 L to 0.0526 L and the intermediate portion 18 may have a length of about 0.895 L to 0.947 L.

Where the tube body 12 has a total length L, the proximal end portion 20 and the distal end portion 22 may both have a length of about 0.0182 L to 0.0364 L and the intermediate portion 18 may have a length of about 0.927 L to 0.964 L.

The tube body 12 may be characterized by a wall diameter to outer diameter ratio as set forth in the equation OD^{x}/t=C where: OD=outer diameter of the tube body, t=wall thickness of the tube body, C is a constant having a value between 6.0 and 18.0 and X=1.25, 1.5 or 1.75.

In some embodiments of the enteral feeding tube 10, C=11.5 to 18.0. In some embodiments of the enteral feeding tube 10, C=8.0 to 12.5. In some embodiments of the enteral feeding tube 10, C=6.0 to 8.0.

An enteral feeding tube 10 of 5-6 FR in diameter may have a second moment of inertia of between about 0.0000004 to 0.000005. An enteral feeding tube 10 of 8-10 Fr in diameter may have a second moment of inertia of between about 0.000004 to 0.00002. An enteral feeding tube 10 of 10-12 Fr in diameter may have a second moment of inertia of between about 0.000011 to 0.000032.

The tube body 12 may have a Shore hardness of between about 70-90 A. In a particularly useful embodiment, the tube body 12 has a Shore hardness of about 85 A.

The tube body 12 may be made from any appropriate material for the construction of an enteral feeding tube 10. Polyurethane is one such material.

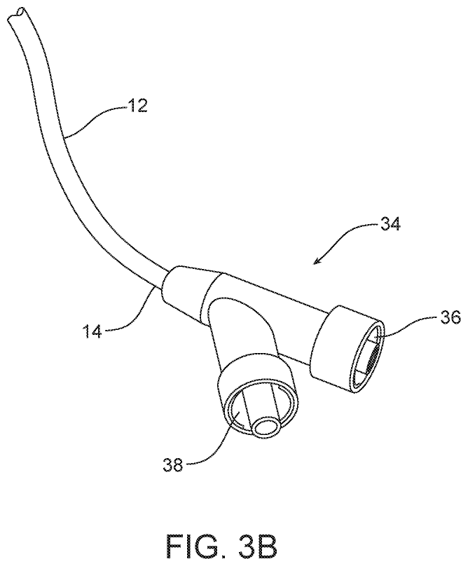

As illustrated in FIG. 3a, the proximal end 14 of the tube body 12 may be connected to a Y port 24 of a type known in the art. Such a Y port 24 includes a first port 26, a second port 28, a first plug 30 adapted for sealing off the first port and a second plug 32 adapted for sealing off the second port. The Y port 25 allows connection of industry standard enteral feeding fittings such as tapered connector feeding sets, catheter tip syringes, and other non-ENFIT devices.

As illustrated in FIG. 3b, the proximal end 14 of the tube body 12 may be connected to an ENFIT adapter 34 of a type known in the art. Such an ENFIT adapter 34 includes a first port 36 and a second port 38. Such an ENFIT adapter 34 allows connection of corresponding ENFIT feeding sets, ENFIT syringes, or other ENFIT devices.

Of course, it should be appreciated that other devices known in the art of enteral feeding tube technology may be connected to the proximal end 14 of the tube body 12 as desired for any particular feeding application.

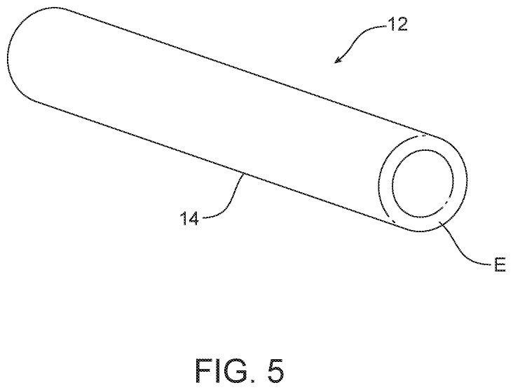

As illustrated in FIG. 1, the distal end 16 of the tube body 12/proximal end 14 may have a rounded edge E to aid in patient insertion. See FIG. 5.

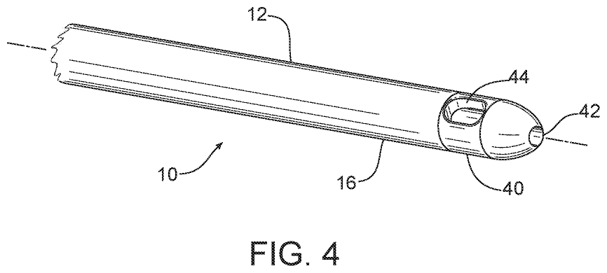

Alternatively, as illustrated in FIG. 4, the distal end 16 of the tube body 12 may be connected to a tip 40. That tip 40 may be rounded and include an end orifice 42 for receiving a guidewire (not shown) of a type used to guide placement of the enteral feeding tube 10 in the gastrointestinal tract, such as the stomach, duodenum or small intestine, of a patient. The tip 40 may also include an exit vent 44 for discharging water, radiographic contrast media, nutritional formula, medications or other fluids as desired from the enteral feeding tube 10.

The tip 40 may be made from any appropriate material including a dissolvable material, if desired, since the primary purpose of the tip 40 is to ease the placement of the enteral tube 10 in the patient. Dissolvable materials useful for this purpose include polymers marketed under the trademark Affinisol® by The Dow Chemical Company of Midland, Mich. and Solplus® by Lubrizol Limited Corporation United Kingdom.

It should also be appreciated that the tube body 12 may include a lubricious coating 46. As illustrated in FIG. 1, that lubricious coating 46 may be provided on the interior wall surface 48 that defines the lumen 50 of the enteral feeding tube 10, on the exterior wall surface 52 or on both the interior and the exterior wall surfaces. Such a lubricious coating 46 on the interior wall surface 48 aids in passing enteral feeding formula and other media from the proximal end 14 of the tube 10 to and through the distal end 16 of the tube where it is discharged. Such a lubricious coating 46 on the outer surface 52 of the tube body 12 aids in displacing the tube 10 through the gastrointestinal tract as the tube is placed for feeding and later removed following treatment.

Materials useful as a lubricious coating 46 include, but are not necessarily limited to hydrophilic permanently lubricious coatings such as HydroMed or HydroThane.

The tube body 12 may also include size and length markings so that a physician may confirm the size and length of the tube 10 within a patient during use. Further, the tube body 12 may include one or more radiopaque markers 54, of a type known in the art, to facilitate placement of the tube 10 and for confirmation of tube position in the gastrointestinal tract.

Advantageously, the enteral feeding tube 10 is characterized by a number of significant benefits and advantages. The reverse taper of the intermediate portion 18 of the tube body extending from the proximal end portion 20 to the distal end portion 22 is clog resistant to the slow flow of viscous fluids such as nutritional media, enteral feeding formula, and medicine, such as ground pills, passing through the tube. Should a clog be encountered, the tube 10 is configured to allow the clearance of the clog by pressure generated with a syringe without the need of more invasive tactics such as enzymatic dissolution or mechanical wire impact.

The wall diameter to OD ratio of the tube is designed to prevent kinking around a bend radius as would be encountered as the tube 10 passes through the nasopharynx.

This disclosure may be considered to relate to the following items.

1. An enteral feeding tube, comprising:

a tube body characterized by an equation

$$\frac{O {D}^{x}}{t} = C$$

where

OD=outer diameter of the tube body,

t=wall thickness of the tube body,

C is a constant having a value between 6.0 and 18.0 and X=1.25, 1.5 or 1.75.

2. The enteral feeding tube of item 1, wherein the tube body includes a proximal end, a distal end and an intermediate portion with an inner diameter and the outer diameter increasing toward the distal end.

3. The enteral feeding tube of item 2, wherein the intermediate portion has a taper ratio between about 0.004 and 0.00015.

4. The enteral feeding tube of item 2, wherein the intermediate portion has a taper ratio between about 0.004 and 0.0006.

5. The enteral feeding tube of item 2, wherein the intermediate portion has a taper ratio between about 0.0015 and 0.00015.

6. The enteral feeding tube of item 2, wherein the intermediate portion has a taper ratio between about 0.00129 and 0.000516.

7. The enteral feeding tube of any of items 2-6, wherein the tube body further includes a proximal end portion extending from the proximal end to the intermediate portion.

8. The enteral feeding tube of item 7, wherein the tube body further includes a distal end portion extending from the distal end to the intermediate portion.

9. The enteral feeding tube of item 8, wherein the proximal end portion has a constant internal diameter A.

10. The enteral feeding tube of item 9, wherein the distal end portion has a constant internal diameter B where A<B.

11. The enteral feeding tube of item 10, wherein A is between about 1.25 and 2.27 mm.

12. The enteral feeding tube of item 11, wherein B is between about 1.72 and 2.75 mm.

13. The enteral feeding tube of item 12, wherein A is about 2.27 and B is about 2.75 mm.

14. The enteral feeding tube of item 12, wherein A is about 1.89 and B is about 2.41 mm.

15. The enteral feeding tube of item 12, wherein A is about 1.25 and B is about 1.72 mm.

16. The enteral feeding tube set forth in any of items 8-15, wherein the tube body has a total length L, the proximal end portion and the distal end portion both have a length of about 0.0071 L to 0.0526 L and the intermediate portion has a length of about 0.895 L to 0.986 L.

17. The enteral feeding tube set forth in any of items 8-15, wherein the tube body has a total length L, the proximal end portion and the distal end portion both have a length of about 0.0091 L to 0.0182 L and the intermediate portion has a length of about 0.964 L to 0.982 L.

18. The enteral feeding tube set forth in any of items 8-15, wherein the tube body has a total length L, the proximal end portion and the distal end portion both have a length of about 0.0071 L to 0.0142 L and the intermediate portion has a length of about 0.971 L to 0.986 L.

19. The enteral feeding tube set forth in any of items 8-15, wherein the tube body has a total length L, the proximal end portion and the distal end portion both have a length of about 0.0263 L to 0.0526 L and the intermediate portion has a length of about 0.895 L to 0.947 L.

20. The enteral feeding tube set forth in any of items 8-15, wherein the tube body has a total length L, the proximal end portion and the distal end portion both have a length of about 0.0182 L to 0.0364 L and the intermediate portion has a length of about 0.927 L to 0.964 L.

21. The enteral feeding tube of any of items 1-20 wherein C=11.5 to 18.0.

22. The enteral feeding tube of any of items 1-20 wherein C=8.0 to 12.5.

23. The enteral feeding tube of any of items 1-20 wherein C=6.0 to 8.0.

24. The enteral feeding tube of any of items 1-23 wherein X=1.5.

25. The enteral feeding tube of any of items 1-23 wherein X=1.25.

26. The enteral feeding tube of any of items 1-23 wherein X=1.75.

27. The enteral feeding tube of any of items 1-26 wherein the tube body has a second moment of inertia of between about 0.000011 and 0.000032.

28. The enteral feeding tube of any of items 1-26 wherein the tube body has a second moment of inertia of between about 0.000004 and 0.00002.

29. The enteral feeding tube of any of items 1-26 wherein the tube body has a second moment of inertia of between about 0.0000004 and 0.000005.

30. The enteral feeding tube of any of items 1-29 wherein the tube body is made from a material having a Shore hardness of between about 70-90 A.

31. The enteral feeding tube of any of items 1-29 wherein the tube body is made from a material having a Shore hardness of about 85 A.

32. The enteral feeding tube of any of items 1-31 wherein the tube body is made from a polyurethane material.

33. The enteral feeding tube of any of items 1-32 wherein the proximal end is connected to a Y port.

34. The enteral feeding tube of any of items 1-32 wherein the proximal end is connected to an ENFIT adapter.

35. The enteral feeding tube of any of items 1-34 wherein the distal end has a rounded edge.

36. The enteral feeding tube of item 35 wherein the distal end is connected to a rounded tip with an exit vent.

37. The enteral feeding tube of any of items 1-36 wherein the tube body includes a lubricious coating.

38. The enteral feeding tube of item 37 wherein the lubricious coating is on an exterior wall surface of the tube body.

39. The enteral feeding tube of item 37 or item 38 wherein the lubricious coating is on an interior wall surface of the tube body that defines a lumen in the tube body.

40. The enteral feeding tube of any of items 1-39, further including an enteral feeding formula in the tube body wherein the enteral feeding formula is discharged from the distal end.

41. The enteral feeding tube of any of items 1-40, wherein the tube body is stiffer at the proximal end portion than the distal end portion.

42. The enteral feeding tube of any of items 1-41, further including size and length markings on the tube body.

43. The enteral feeding tube of any of items 1-42, wherein the tube body includes a radiopaque marker.

44. The enteral feeding tube of item 8, wherein the tube body has a proximal end portion outer diameter of between about 1.58 mm and 3.25 mm and a proximal end portion inner diameter of between about 1.25 mm and 2.27 mm.

45. The enteral feeding tube of claim 44, wherein the tube body has a distal end portion outer diameter of between about 2.30 mm and 4.17 mm and a distal end portion inner diameter of between about 1.72 mm and 2.75 mm.

46. An enteral feeding tube, comprising:
a tube body having a proximal end portion, a distal end portion and an intermediate tapering portion between the proximal end portion and the distal end portion wherein the tube body has a total length of L, the proximal end portion and the distal end portion both have a length of about 0.0071 L to 0.0526 L and the intermediate tapered portion has a length of about 0.895 L to 0.986 L.

47. The enteral feeding tube of item 46 wherein the proximal end portion and the distal end portion have a length of about 0.0091 L to 0.0182 L and the intermediate tapered portion has a length of about 0.964 L to 0.982 L.

48. The enteral feeding tube of item 46 wherein the proximal end portion and the distal end portion have a length of about 0.0071 L to 0.0142 L and the intermediate tapered portion has a length of about 0.971 L to 0.98 L.

49. The enteral feeding tube of item 46 wherein the proximal end portion and the distal end portion have a length of about 0.0263 L to 0.0526 L and the intermediate tapered portion has a length of about 0.895 L to 0.947 L.

50. The enteral feeding tube of item 46 wherein the proximal end portion and the distal end portion have a length of about 0.0182 L to 0.0364 L and the intermediate tapered portion has a length of about 0.927 L to 0.964 L.

51. The enteral feeding tube of any of items 46-50, wherein the intermediate portion has a taper ratio between about 0.004 cm/cm and 0.00025 cm/cm.

52. The enteral feeding tube of any of items 46-50, wherein the intermediate portion has a taper ratio between about 0.004 and 0.0006 cm/cm.

53. The enteral feeding tube of any of items 46-50, wherein the intermediate portion has a taper ratio between about 0.0015 and 0.00025 cm/cm.

54. The enteral feeding tube of any of items 46-50, wherein the intermediate portion has a taper ratio between about 0.00129 and 0.000516 cm/cm.

55. The enteral feeding tube of any of items 46-54, wherein the proximal end portion has a constant internal diameter A.

56. The enteral feeding tube of any of items 46-55, wherein the distal end portion has a constant internal diameter B where A<B.

57. The enteral feeding tube of item 56, wherein A is between about 1.25 and 2.27 mm.

58. The enteral feeding tube of item 57, wherein B is between about 1.72 and 2.75 mm.

59. The enteral feeding tube of item 56, wherein A is 2.27 and B is 2.75 mm.

60. The enteral feeding tube of item 58, wherein A is 1.89 and B is 2.41 mm.

61. The enteral feeding tube of item 58, wherein A is 1.25 and B is 1.72 mm.

62. The enteral feeding tube of any of items 46-61 wherein the tube body has a second moment of inertia of between about 0.000011 and 0.000032.

63. The enteral feeding tube of any of items 46-61 wherein the tube body has a second moment of inertia of between about 0.000004 and 0.000020.

64. The enteral feeding tube of any of items 46-61 wherein the tube body has a second moment of inertia of between about 0.0000004 and 0.000005.

65. The enteral feeding tube of any of items 46-64 wherein the tube body is made from a material having a Shore hardness of between about 70-90 A.

66. The enteral feeding tube of any of items 46-64 wherein the tube body is made from a material having a Shore hardness of about 85 A.

67. The enteral feeding tube of any of items 46-64 wherein the tube body is made from a polyurethane material.

68. The enteral feeding tube of any of items 46-67 wherein the proximal end is connected to a Y port.

69. The enteral feeding tube of any of items 46-67 wherein the proximal end is connected to an ENFIT adapter.

70. The enteral feeding tube of any of items 46-69 wherein the distal end has a rounded edge.

71. The enteral feeding tube of item 70 wherein the distal end is connected to a rounded tip with an exit vent.

72. The enteral feeding tube of any of items 46-71 wherein the tube body includes a lubricious coating.

73. The enteral feeding tube of items 72 wherein the lubricious coating is on an exterior wall surface of the tube body.

74. The enteral feeding tube of item 72 or item 73 wherein the lubricious coating is on an interior wall surface of the tube body that defines a lumen in the tube body.

75. The enteral feeding tube of any of items 46-74, further including an enteral feeding formula in the tube body wherein the enteral feeding formula is discharged from the distal end.

76. The enteral feeding tube of any of items 46-75, wherein the tube body is stiffer at the proximal end than the distal end.

77. The enteral feeding tube of any of items 46-76, further including size and length markings on the tube body.

78. The enteral feeding tube of any of items 46-77, wherein the tube body includes a radiopaque marker.

Each of the following terms written in singular grammatical form: “a”, “an”, and the”, as used herein, means “at least one”, or “one or more”. Use of the phrase One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of.” Each of the phrases “consisting of and “consists of, as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic” being a system unit system sub-unit device, assembly, sub-assembly, mechanism, structure, component or element or, peripheral equipment utility, accessory, or material, step or procedure, sub-step or sub-procedure), but only if each such additional feature or characteristic” does not materially alter the basic novel and inventive characteristics or special technical features, of the claimed item.

Terms of approximation, such as the terms about, substantially, approximately, etc., as used herein, refers to ±10% of the stated numerical value. Use of the terms parallel or perpendicular are meant to mean approximately meeting this condition, unless otherwise specified.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although the inventions of this disclosure have been illustratively described and presented by way of specific exemplary embodiments, and examples thereof, it is evident that many alternatives, modifications, or/and variations, thereof, will be apparent to those skilled in the art Accordingly, it is intended that all such alternatives, modifications, or/and variations, fall within the spirit of, and are encompassed by, the broad scope of the appended claims.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1-78. (canceled)

79. An enteral feeding tube, comprising:
a tube body characterized by an equation
$$\frac{O {D}^{x}}{t} = C$$
where
OD=outer diameter of the tube body,
t=wall thickness of the tube body,
C is a constant having a value between 6.0 and 18.0 and X=1.25, 1.5 or 1.75, wherein the tube body includes a proximal end portion extending from a proximal end to an intermediate portion and a distal end portion extending from the intermediate portion to a distal end, and wherein the intermediate portion defines a lumen having an inner diameter and an outer diameter each increasing toward the distal end portion.

80. The enteral feeding tube of claim 79, wherein the tube body has a total length L, the proximal end portion and the distal end portion each have a length of about 0.0071 L to 0.0526 L and the intermediate portion has a length of about 0.895 L to 0.986 L.

81. The enteral feeding tube of claim 79, wherein the intermediate portion has a taper ratio selected from the group consisting of between about 0.004 and 0.00015, between about 0.004 and 0.0006, and between about 0.0015 and 0.00015, and between about 0.00129 and 0.000516.

82. The enteral feeding tube of claim 79, wherein the proximal end portion has a constant internal diameter A.

83. The enteral feeding tube of claim 82, wherein the distal end portion has a constant internal diameter B where A<B.

84. The enteral feeding tube of claim 83, wherein A is between about 1.25 mm and 2.27 mm.

85. The enteral feeding tube of claim 84, wherein B is between about 1.72 mm and 2.75 mm.

86. The enteral feeding tube of claim 83, wherein the constant internal diameter A of the proximal end portion and the constant internal diameter B of the distal end portion are selected from the group consisting of A is about 2.27 mm and B is about 2.75 mm, A is about 1.89 mm and B is about 2.41 mm, and A is about 1.25 mm and B is about 1.72 mm.

87. The enteral feeding tube of claim 79, wherein the constant C is selected from the group consisting of between 11.5 to 18.0, between 8.0 to 12.5, and between 6.0 to 8.0.

88. The enteral feeding tube of claim 79, wherein X is selected from the group consisting of 1.5, 1.25, and 1.75.

89. The enteral feeding tube of claim 79, wherein the tube body has a second moment of inertia selected from the group consisting of between about 0.000011 and 0.000032, about 0.000004 and 0.00002, and about 0.0000004 and 0.000005.

90. The enteral feeding tube of claim 79, wherein the tube body is made from a material having a Shore hardness of between about 70-90 A.

91. The enteral feeding tube of claim 79, wherein the tube body has a proximal end portion outer diameter of between about 1.58 mm and 3.25 mm and a proximal end portion inner diameter of between about 1.25 mm and 2.27 mm.

92. The enteral feeding tube of claim 79, wherein the tube body has a distal end portion outer diameter of between about 2.30 mm and 4.17 mm and a distal end portion inner diameter of between about 1.72 mm and 2.75 mm.

93. An enteral feeding tube, comprising:
a tube body having a distal end portion for placement within a patient, a proximal end portion, and an intermediate tapering portion between the proximal end portion and the distal end portion wherein the tube body has a total length of L, the proximal end portion and the distal end portion each have a length of about 0.0071 L to 0.0526 L and the intermediate tapering portion has a length of about 0.895 L to 0.986 L.

94. The enteral feeding tube of claim 93, wherein the intermediate tapering portion tapers toward the proximal end portion.

95. The enteral feeding tube of claim 94, wherein the proximal end portion and the distal end portion each have a length of about 0.0091 L to 0.0182 L and the intermediate tapered portion has a length of about 0.964 L to 0.982 L.

96. The enteral feeding tube of claim 93, wherein the proximal end portion has a constant internal diameter A.

97. The enteral feeding tube of claim 96, wherein the distal end portion has a constant internal diameter B where A<B.

98. The enteral feeding tube of claim 93, wherein the tube body has a second moment of inertia of between about 0.000011 and 0.000032.

99. The enteral feeding tube of claim 93, wherein the tube body is made from a material having a Shore hardness of between about 70-90 A.

100. The enteral feeding tube of claim 93, wherein the distal end is connected to a rounded tip with an exit vent.

101. The enteral feeding tube of claim 93, wherein the tube body is stiffer at the proximal end than the distal end.

102. An enteral feeding tube, comprising:
a tube body having distal and proximal end portions, and an intermediate portion positioned between the distal and proximal portions and tapering toward the proximal portion, wherein the proximal end portion has a constant internal diameter A and the distal end portion has a constant internal diameter B, where A<B.

103. The enteral feeding tube of claim 102, wherein the tube body has a total length L, the proximal end portion and the distal end portion each have a length of about 0.0071 L to 0.0526 L and the intermediate portion has a length of about 0.895 L to 0.986 L.

104. The enteral feeding tube of claim 102, wherein the distal end is rounded.

105. The enteral feeding tube of claim 102, further comprising a tip connected to the distal end portion.

106. The enteral feeding tube of claim 105, wherein at least a portion of the tip is dissolvable.
